(19) United States
(12) Patent Application Publication
(10) Pub. No.: US 2008/0170829 A1
(43) Pub. Date: Jul. 17, 2008

(54) Optical fiber assemblage

(75) Inventors: Masayoshi Suzuki, Shizuoka-shi (JP); Kyouichi Sasaki, Shizuoka-shi (JP)

Correspondence Address: ARENT FOX LLP, 1050 CONNECTICUT AVENUE, N.W., SUITE 400, WASHINGTON, DC, 20036, US

(73) Assignee: TOMOEGAWA CO., LTD.

(21) Appl. No.: 11/898,969

(22) Filed: Sep. 18, 2007

(30) Foreign Application Priority Data
Sep. 19, 2006 (JP) 2006-252051

(51) Int. Cl. G02B 6/04

(52) U.S. Cl. 385/115

(57) ABSTRACT

An optical fiber assemblage can maintain a desired shape, and the optical fibers can be interconnected with good efficiency of construction and in small spaces. The optical fiber assemblage has optical fibers arranged in parallel, at least one support wire having shape-maintaining characteristics arranged in proximity to the optical fibers, and a holding part for holding the optical fibers and the support wire in a unified manner.

### BACKGROUND OF THE INVENTION

1. Technical Field

The present invention relates to an optical fiber assemblage, in which optical fibers are gathered together, and which is used in optical communications and optical information processing such as in an optical circuit package or an optical circuit device.

2. Background Art

Conventionally, optical fiber assemblages, such as optical fiber ribbon in which optical fibers are arranged in parallel and in which the fibers are covered with resins or the like to unify the bundled optical fibers, are known (see Japanese Unexamined Patent Application Publication No. 2003-021764).

These optical fiber assemblages are used when optical fibers are contained in an optical fiber cable at high density and in a compact state. In addition, they may also be used as multifiber interconnections of optical fibers between devices or within a device to help reduce the space for the interconnection.

However, the conventional optical fiber assemblages are difficult to maintain in a desired interconnection shape due to the rigidity of the optical fibers or bending characteristics. Therefore, there are problems when an optical fiber assemblage is arranged so as to be bent in a narrow space between circuit boards or is arranged so as to be threaded through parts.

In addition, if the shape of interconnection can be maintained, it is necessary to use a case or to use a tape and an interconnecting member for fixing a bent part. Therefore, there has been a problem in that the efficiency of construction is decreased or the space for interconnection is increased.

### SUMMARY OF THE INVENTION

The present invention was completed in view of the above circumstances, and an object of the present invention is to provide an optical fiber assemblage that can maintain a huge variety of shapes and that allows interconnecting optical fibers at a high efficiency of construction and in small spaces.

The present invention solves the above-described problems by way of the following technical aspects.

(1) An optical fiber assemblage has optical fibers arranged in parallel, at least one support wire having a shape-maintaining characteristic and arranged in proximity to the plural optical fibers, and a holding part holding the optical fibers and the holding cable in a unified manner.

(2) In the optical fiber assemblage according to the above aspect (1), the holding part is made of a silicone rubber or resin material.

(3) In the optical fiber assemblage according to the above aspect (1), the holding part covers over one surface or both surfaces of the optical fibers and the support wire.

(4) In the optical fiber assemblage according to the above aspect (1), the outer diameter of the support wire L1 is not less than the outer diameter of the optical fiber L2.

(5) In the optical fiber assemblage according to the above aspect (1), the support wire is arranged between the optical fibers.

(6) In the optical fiber assemblage according to the above aspect (1), the support wire is a metallic wire.

(7) The optical fiber assemblage according to the above aspect (1) has the holding part at plural points.

(8) In the optical fiber assemblage according to the above aspect (1), arrangement of the optical fibers is crossed over so as to switch.

(9) In the optical fiber assemblage according to the above aspect (1), the optical fibers are branched.

By the present invention, the optical fiber assemblage, which enables the maintaining of various shapes and allows the interconnecting of optical fibers at a high efficiency of construction and in small spaces, can be provided.

### BRIEF DESCRIPTION OF DRAWINGS

FIG. 1 is a perspective view showing the optical fiber assemblage of Embodiment 1.

FIG. 2 is a front view showing the optical fiber assemblage of Embodiment 1.

FIG. 3 is a perspective view showing the optical fiber assemblage of Embodiment 1 bent.

FIG. 4 is a perspective view showing the optical fiber assemblage of Embodiment 2.

FIG. 5 is a front view showing the optical fiber assemblage of Embodiment 2.

FIG. 6 is a perspective view showing the optical fiber assemblage of Embodiment 3.

FIG. 7 is a perspective view showing the optical fiber assemblage of Embodiment 4.

FIG. 8 is a perspective view showing the optical fiber assemblage of Embodiment 5.

FIG. 9 is a perspective view showing the coating device.

### EXPLANATION OF REFERENCE NUMERALS

2a to 2d: Optical fiber, 3: Support wire, 4, 4a to 4d: Holding part, 11 to 15: Optical fiber assemblage, 104: Coating start position, 105: Coating end position, 106: Optical fiber assemblage arranging point, 107: Tape, 108: Raw material supplying device, 109: Single-axis control robot, 110: Substrate board, 111: Ball screw axis, 112: Movable unit, 113: Rubber tube, 114: Driving motor, 115: Axis receiver, L1: Outer diameter of support wire, L2: Outer diameter of optical fiber, N: Needle, P: Non-holding part

### PREFERRED EMBODIMENTS OF THE INVENTION

Next, embodiments of the optical fiber assemblage of the present invention will be explained in detail.

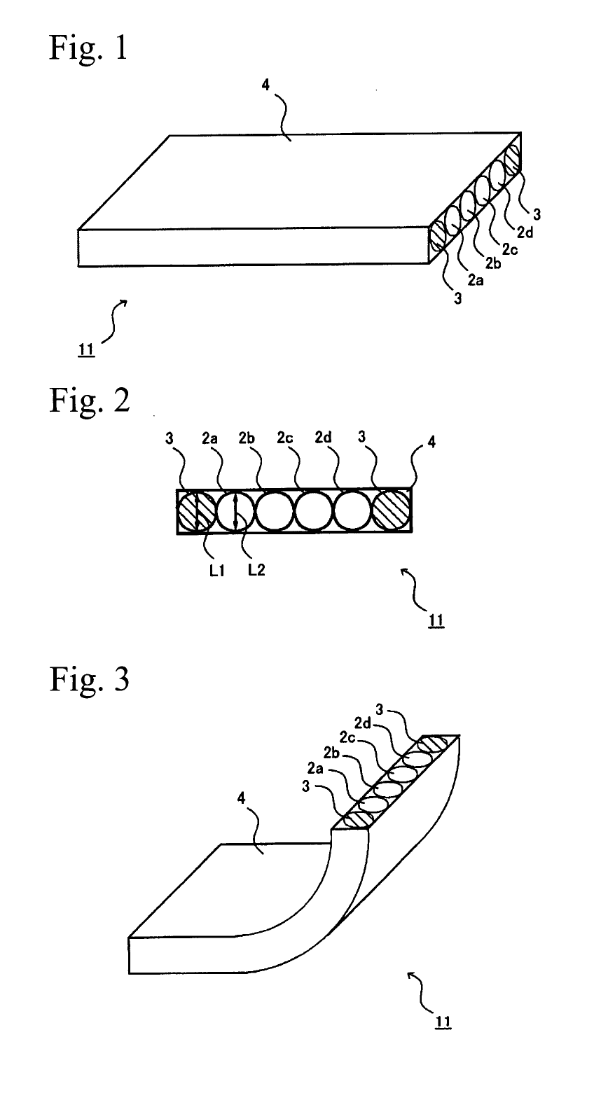

Embodiment 1 is explained below with reference to FIGS. 1 to 3.

FIG. 1 is a perspective view showing the optical fiber assemblage of Embodiment 1.

Reference numerals 2a to 2d are optical fibers arranged in parallel, 3 is a support wire arranged next to the optical fibers 2a to 2d, 4 is a holding part holding the optical fibers 2a to 2d together with the support wire 3, and 11 is an optical fiber assemblage of Embodiment 1. Note that support wire 3 is indicated by hatching.

Parallel arrangement of the optical fibers of the present invention means that each optical fiber is arranged at a desired location, including crossing over so as to switch and branching. Furthermore, gaps between each optical fiber may be unequal.

The optical fiber assemblage 11 of Embodiment 1 is formed by the four optical fibers 2a to 2d, two support wires 3, and holding part 4.

The support wires 3 are arranged at both edges of the optical fibers 2a to 2d arranged parallel, sandwiching the optical fibers between the two support wires. The holding part 4 covers both the upper side and the lower side of the optical fibers 2a to 2d and the support wire 3. It should be noted that it is not always necessary that the holding part 4 cover the entirety of the optical fibers 2a to 2d and the support wire 3.

FIG. 2 is a front view showing the optical fiber assemblage of Embodiment 1.

L1 is the outer diameter of the support wire and L2 is the outer diameter of the optical fiber.

The outer diameter of the support wire 3 used in the present invention is not particularly limited; however, it is desirable that the outer diameter of the support wire L1 be not less than the outer diameter of the optical fiber L2. In the case in which L1 and L2 are the same, the support wire can be handled in a manner similar to that for the generally used optical fiber assemblage having the same thickness, and in the case in which L1 is greater than L2, the support wire 3 can protect the optical fibers 2a to 2d when stress is applied from the lateral surface. In this way, each case has its own advantage. However, in the case in which L2 is greater than L1, it is undesirable that the strength of the support wire 3 be decreased because that would complicate the maintaining of the shape. In addition, the shape of the cross section of the support wire 3 is not particularly limited; however, it is desirable that the shape be circular since that would allow it to be handled in a manner similar to that of the optical fiber.

FIG. 3 is a perspective view showing the optical fiber assemblage of Embodiment 1 being bent.

Since the support wires 3 at both edges maintain the bent shape when the optical fiber assemblage of the present invention is bent, the optical fibers 2a to 2d between the support wires also can be maintained in the bent shape. Therefore, by bending the optical fiber assemblage 11 at a desired point, the optical fibers 2a to 2d can be arranged while being bent in a shape appropriate for the environment therearound. It should be noted that in addition to the effects obtained by bending, similar effects can be obtained when twisting.

The optical fibers 2a to 2d used in the present invention are not particularly limited, and they may be selected depending on the intended use.

For example, any of a multimode or single-mode, and an optical fiber made of a material such as quartz or plastic, may be used. Furthermore, it is more preferable and more effective that a fiber having a low allowable bending radius or a holey fiber be used. It should be noted that the length of the optical fiber is also not particularly limited. Furthermore, the optical fiber can be cut to adjust the length, and the optical fiber can be freely processed so that the shape of a fiber is partially changed or a tube is used to cover the fiber.

It is necessary that the support wire 3 of the present invention have shape-maintaining characteristics. The shape-maintaining characteristics in this case are characteristics by which the shape can be maintained against bending and twisting. Practically, a metallic wire, resin wire or the like can be used.

As the metallic wire, for example, wire, enamel wire, piano wire, copper wire, tough pitch steel wire, oxygen-free copper wire, red brass wire, brass wire, phosphor bronze wire, tin-containing copper wire, silver-containing copper wire, stainless steel wire, nickel wire, brass wire, plating wire, shape-memory alloy wire or the like can be used. In particular, it is desirable to use wire and enameled wire that are materials which are unlikely to corrode and which are flexible and generally versatile. It should be noted that a coating liquid such as coloring coating, a rust-proofing agent, or an adhesive agent can be applied on the above-mentioned wires.

As the resin wire material, a wire with a resin material having a high degree of plasticity such as an ester-type urethane resin, polyimide, phenol, polystyrene, polyethylene or the like, and a shape memory resin in which a stationary phase which is cross-linked or partially crystallized and a reversible phase are mixed, and the shape can be regenerated by heat, pH change, electric stimulation, light stimulation or the like, such as polyester, polyurethane, styrene-butadiene, polynorbonene, trans-polyisoprene or the like, can be used in the present invention.

The holding part 4 used in the present invention should hold the optical fibers 2a to 2d and the support wire 3.

Therefore, it is desirable that a material which can be fitted or adhered sufficiently on the outermost material of the optical fibers 2a to 2d and the support wire 3 be used as a material of the holding part 4. Furthermore, it is desirable that the flexibility be sufficient to improve handling characteristics of the optical fiber assemblage. As a material satisfying the above conditions, for example, a silicone-type resin material may be mentioned. In particular, among them, a silicone rubber material is desirable.

Since intermolecular attraction of the Si—O bond is weak in the silicone rubber material, tearing strength is low, and it can be easily torn from the edge. On the other hand, since the silicone rubber material can elongate and has tensile strength in addition to superior flexibility due to the elasticity of rubber, high flexibility can be exhibited against movement of the optical fibers 2a to 2d adhered therewith, and the material is resistant to tearing at the middle part. That is, it can be easily branched from the edge during production, and by fixing the edge part after that, a fanned-out optical fiber assemblage having resistance to tearing during use can be provided.

Furthermore, since siloxane bonding has superior heat resistance, heat-resistance maintaining characteristics are superior, and adhesive characteristics are superior in high temperature and low temperature environments. Therefore, in the case in which it is used as an interconnecting member, deterioration is not observed even in a high temperature environment up to 250° C. or a low temperature environment down to −50° C., and the holding condition of the optical fibers 2a to 2d can be stably maintained.

In addition, since the silicone rubber material has superior characteristics in electrical insulation, chemical resistance, weather resistance, and water resistance, the silicone rubber material can be adhered to many kinds of material, by using primer, if necessary. Therefore, it can be adhered, for example, to a plastic fiber made of a fluorine-type resin, and to a fiber of which the clad layer is coated with a fluorine-type resin.

Among the silicone rubber materials, from the viewpoint of processes that are easy to conduct, it is desirable to use a room-temperature curing silicone rubber (RTV) in which the curing reaction may be promoted at room temperature. More desirably, since the amount of by-product that is generated is low and workability is good, an addition reaction curing type, a condensation reaction curing type, and a monocomponent type which is produced by packing all the necessary components into a closed container such as a tube or cartridge, are desirable.

Furthermore, it is desirable that the holding part 4 of the present invention be easily tearable by holding both edges and pulling, so as to be able to interconnect the optical fibers 2a to 2d for each single optical fiber, if necessary.

It is desirable to use a material having a tearing strength of not more than 29 kgf/cm. In the case in which the tearing strength is not less than 29 kgf/cm, the tearing resistance increases and workability deteriorates, and since a large load is required to tear it, a covering material may be broken or damaged. The tearing strength is more desirably not more than 10 kgf/cm.

It should be noted that the tearing strength means a value of strength measured in the test according to JIS K6250 (Example of method of physical test of vulcanized rubber and thermo-plastic rubber) and JIS K6252 (Method of tearing test of vulcanized rubber). That is, a platy angle-shaped test piece having a cut off part was used as the test piece, the sample piece was pulled, and a maximum tearing strength in the case in which a stress when the torn part increases in size was measured.

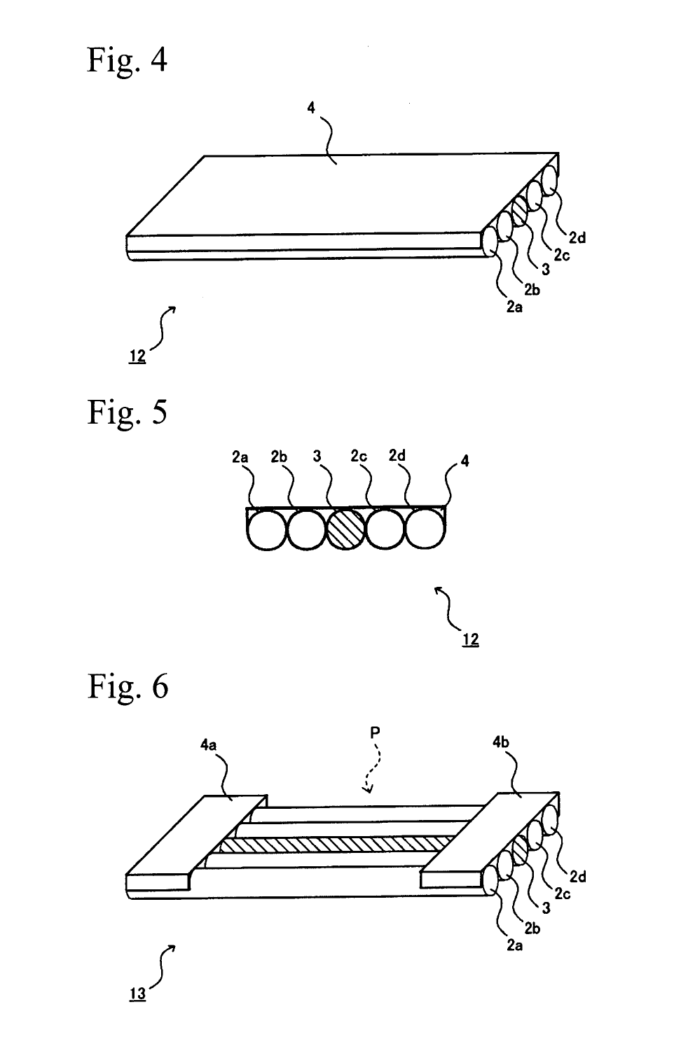

Embodiment 2 is explained with reference to FIGS. 4 and 5.

FIG. 4 is a perspective view showing the optical fiber assemblage of Embodiment 2.

Reference numeral 12 is the optical fiber assemblage of Embodiment 2.

In the optical fiber assemblage 12 of Embodiment 2, the support wire 3 is positioning at the middle of the four optical fibers 2a to 2d arranged in parallel.

In the optical fiber assemblage 12 of Embodiment 2, since the shape can be changed by the one support wire 3 at the center, control of the interconnection is made easier.

FIG. 5 is a front view showing the optical fiber assemblage of Embodiment 2.

As shown in FIG. 5, the holding part 4 covers over only one surface (the upper side) of the optical fibers 2a to 2d and the support wire 3.

Therefore, the optical fiber assemblage 12 of Embodiment 2 has superior flexibility and can be bent easily compared with the optical fiber assemblage 11 of Embodiment 1.

It should be noted that the holding part 4 is not limited to only the case of arrangement on both sides or one side, and the present invention can include a case in which the holding part is arranged among the optical fibers 2a to 2d and the support wire 3.

Furthermore, at least one support wire 3 is sufficient in the present invention, and it can be arranged at a certain position. Controlling of the interconnection becomes easier if the number of wires is decreased, and efficiency of maintaining shape can be improved if the number of wires is increased. In addition, arrangement of the support wire can be controlled depending on direction of bending, angle of bending, and position of bending.

Embodiment 3 is explained with reference to FIG. 6.

FIG. 6 is a perspective view showing the optical fiber assemblage of Embodiment 3.

Reference numerals 4a and 4b indicate the holding parts, 13 is the optical fiber assemblage of Embodiment 3, and P is the non-holding part.

The optical fiber assemblage 13 of Embodiment 3 has the holding parts 4a and 4b at plural positions, and there is the non-holding part P where the optical fibers 2a to 2d are not held therebetween. The optical fibers 2a to 2d of the non-holding part P can move freely to some extent, and tension caused by bending and twisting can be reduced. Therefore, if the optical fiber assemblage 13 of Embodiment 3 is bent and twisted, micro-bends and light-loss are unlikely to occur, and the shape can be maintained by the support wire.

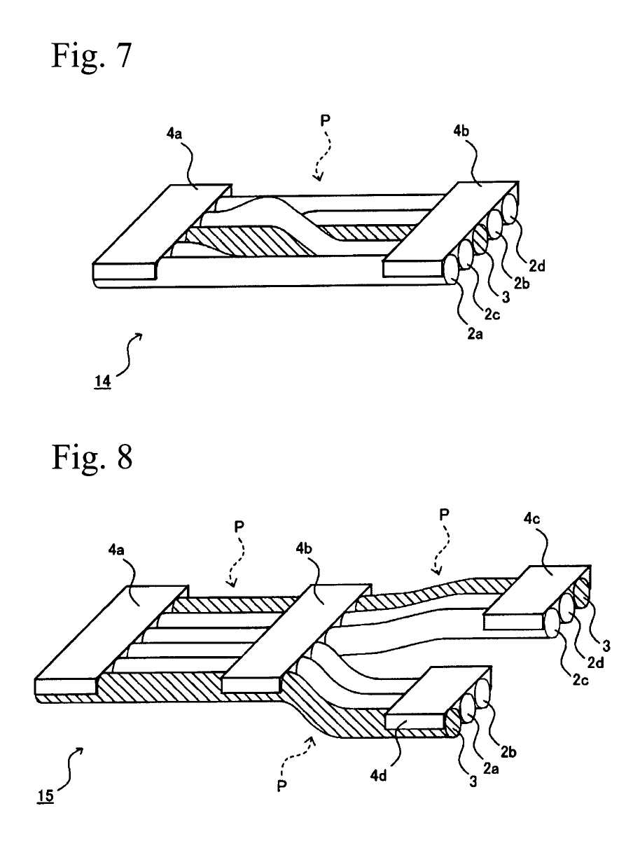

Embodiment 4 is explained with reference to FIG. 7.

FIG. 7 is a perspective view showing the optical fiber assemblage of Embodiment 4.

Reference numeral 14 is the optical fiber assemblage of Embodiment 4.

In the optical fiber assemblage 14 of Embodiment 4, the optical fibers 2b and 2c cross over and their arrangement is thereby switched. By the crossing over, the optical fibers can be freely arranged in a desired arrangement. It should be noted that the arrangement of the crossing over is not limited in particular, and it can be selected depending on the pattern of interconnection.

Embodiment 5 is explained with reference to FIG. 8.

FIG. 8 is a perspective view showing the optical fiber assemblage of Embodiment 5.

Reference numerals 4a, 4b, 4c, and 4d indicate the holding parts, and 15 is the optical fiber assemblage of Embodiment 5.

The optical fiber assemblage 15 of Embodiment 5 is formed by the four optical fibers 2a to 2d, the support wires 3 which are arranged at both edges of the optical fibers 2a to 2d sandwiching them, and the holding parts 4a to 4d which cover one upper surface of the optical fibers 2a to 2d and the support wires 3.

In the optical fiber assemblage 15 of Embodiment 5, the optical fibers 4a to 4d are branched to the optical fibers 2a and 2b, and the optical fibers 2c and 2d, at the non-holding part P. In addition, the support wires 3 on both edges are also branched according to branching of the optical fibers 2a to 2d.

By the branching, the connection of four fibers at the holding part 4b can be changed to connections of two fibers at the holding parts 4c and 4d, to improve the degree of freedom of interconnection or connection. In addition, since mutually different configurations can be set by each support wire at the holding parts 4c and 4d after branching, each interconnection shape can be fitted to each interconnection position. At this time, location or length of branching, and position of branching, are not limited in particular, and they can be freely selected depending on interconnection design.

Next, the process for production of the optical fiber assemblage of the present invention is explained.

The optical fiber assemblage of the present invention can be produced, for example, via a process in which optical fibers are arranged in parallel and support wire is arranged next to the optical fibers, and a process in which coating material is applied to the optical fibers and the support wire and the coating is dried and/or hardened to form a holding part.

The optical fibers can be arranged at a desired position, and switching and branching can be employed. Furthermore, gaps between each cable may be nonuniform.

The support wires can be set next to the optical fiber, and the support wires can be set sandwiching the optical fibers or set at the center of the optical fibers. Furthermore, at least one support wire is employed in the present invention.

A process for coating the coating material is not particularly limited, and for example, the method disclosed in Japanese Unexamined Patent Application Publication No. 2004-240152, in which single optical fibers are arranged on a flat surface, coating material is applied thereon, and the coated material is molded by a molding jig, can be employed.

As a drying and/or hardening method, standing at room temperature, heating, irradiating with ultraviolet light, or the like, can be employed, depending on characteristics of the coating material.

As explained above, the optical fiber assemblage of the present invention is produced.

In addition, as disclosed in Japanese Patent Application No. 2006-151698, the optical fiber assemblage of the present invention can be produced by preparing in advance an optical fiber assemblage and bundling member (holding part) having grooves which fit to the shape of the optical fibers, and by holding the optical fibers and the support wires on the grooves.

### EXAMPLES

Next, the present invention is explained with reference to the following Examples.

It should be noted that the present invention is not limited to these Examples.

### Example 1

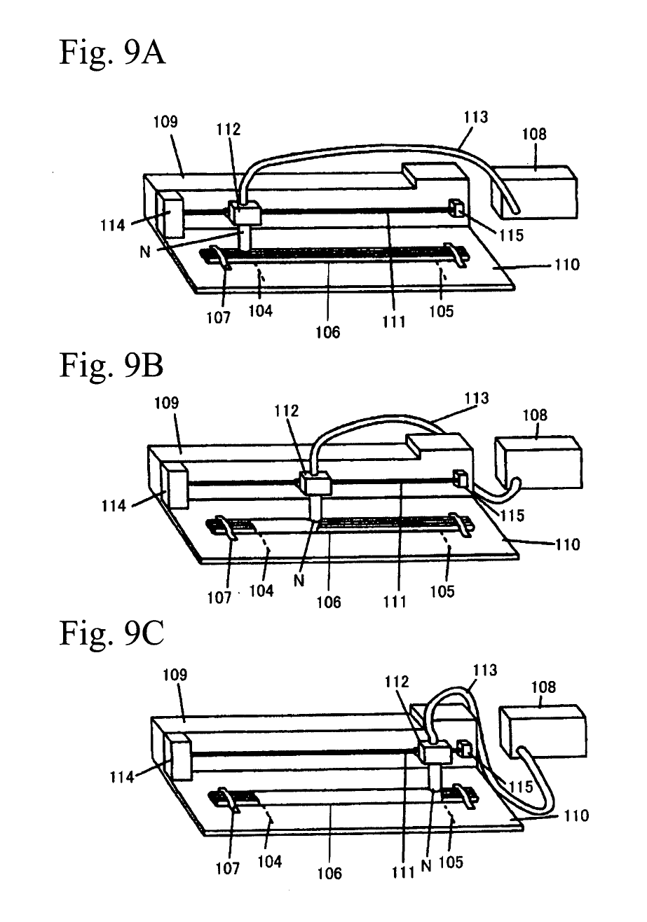

The coating device shown in FIG. 9 was used to produce the optical fiber assemblage of Example.

Reference numeral 104 is a coating start position, 105 is a coating end position, 106 is an arranging position of the optical fiber assemblage, 107 is a tape, 108 is a raw material supplying device, 109 is a single-axis control robot, 110 is a substrate board, 111 is a ball screw axis, 112 is a movable unit, 113 is a rubber tube, 114 is a driving motor, 115 is an axis receiving part, and N is a needle.

This coating device is mainly formed by the single-axis control robot 109 and the raw material supplying device 108, and the single-axis control robot 109 has the substrate board 110 on which the optical fibers are placed. Furthermore, the ball screw axis 111 is arranged along its longitudinal direction, the driving motor 114 is arranged on one edge part of the ball screw axis 111, and the other edge part is supported by the axis receiving part 115. The movable unit 112 is threadably mounted on this ball screw axis 111, and the needle N for supplying raw material is arranged on the movable unit 112 vertical to the surface of substrate board 110. The needle N is connected to the raw material supplying device 108 via a flexible rubber tube 113.

The optical fiber assemblage of Example 1 corresponds to Embodiment 1 shown in FIGS. 1 to 3.

First, as shown in FIG. 9A, four optical fibers 2a to 2d (produced by Sumitomo Electric Industries, Ltd., quartz-type single mode fiber, outer diameter 0.25 mm) having a length of 1 m were arranged parallel on the arranging position of optical fiber assemblage 106 of the substrate board 110. Next, two support wires 3 (enameled cable, outer diameter 0.25 mm) having a length of 1 m were arranged parallel at both edges of the optical fibers 2a to 2d. They were fixed by the tape 107.

Next, the needle N (inner diameter 1.5 mm) was fixed on the movable unit 112 so that the height of its tip was 0.1 mm from the surface of the optical fibers 2a to 2d, and the needle N was moved to the coating start position 104 from which the coating was performed (position 10 cm from the tip of the optical fibers 2a to 2d) and adjusted so that the center of the needle N comes to the center of the four optical fibers 2a to 2d.

Next, as shown in FIGS. 9B and 9C, the coating material was discharged from the needle N while the movable unit 112 was moved along the direction of axis of optical fibers 2a to 2d to the coating end position 105 (position 90 cm from the tip of the optical fibers 2a to 2d), to coat the coating material on an upper surface of the optical fibers 2a to 2d and the support wire 3.

It should be noted that an ultraviolet curable resin (Biscotack PM-654, produced by Osaka Organic Chemical Industry, Ltd.) was used as the coating material, and a dispenser was used as the raw material supplying device 108 to supply the coating material.

Next, ultraviolet light was irradiated on the coated material (irradiation intensity: 20 mW/cm², 10 seconds) to harden it. After that, the tape 107 was removed, the fibers were turned over, and a similar treatment was performed on the back surface to cover both surfaces, to form the holding part 4. As explained above, the optical fiber assemblage of Example 1 was produced.

### Example 2

The optical fiber assemblage of Example 2 is similar to that of Embodiment 1 shown in FIGS. 1 to 3.

The optical fiber assemblage of Example 2 was produced in a manner similar to that of Example 1, except that thermo-setting silicone rubber resin (produced by GE Toshiba Silicone Inc, trade name: TSE392, tearing strength: 5 kgf/cm) was used as a coating material and hardening was performed by a drying device at 120° C. for 1 hour.

### Example 3

The optical fiber assemblage of Example 3 is similar to that of Embodiment 2 shown in FIGS. 4 and 5.

The optical fiber assemblage of Example 3 was produced in a manner similar to that of Example 2, except that the coating material was coated only on one surface.

### Example 4

The optical fiber assemblage of Example 4 is similar to that of Embodiment 3 shown in FIG. 6.

The optical fiber assemblage of Example 4 was produced in a manner similar to that of Example 3, except that from 40 cm to 60 cm from the tip of the optical fibers 2a to 2d was masked with a plastic tape before coating the coating material, and the plastic tape was removed after hardening of the coating material to form holding parts at plural points and to form non-holding part R

### Comparative Example 1

The optical fiber assemblage of Comparative Example 1 was produced in a manner similar to that of Example 1, except that the support wire was not used.

### Comparative Example 2

The optical fiber assemblage of Comparative Example 2 was produced in a manner similar to that of Example 2, except that the support wire was not used.

### Comparative Example 3

The optical fiber assemblage of Comparative Example 3 was produced in a manner similar to that of Example 3, except that the support wire was not used.

### Comparative Example 4

The optical fiber assemblage of Comparative Example 4 was produced in a manner similar to that of Example 4, except that the support wire was not used.

The main conditions of the Examples and the Comparative Examples are shown in Table 1.

TABLE 1

| | | Coating material to produce | |
|---|---|---|---|
| | Support wire | the holding part | Other conditions |
| Example 1 | Employed | Ultraviolet curable resin | Holding part at both surfaces |
| Example 2 | Employed | Silicone rubber resin | Holding part at both surfaces |
| Example 3 | Employed | Silicone rubber resin | Holding part at one surface |
| Example 4 | Employed | Silicone rubber resin | Holding part at one surface |
| | | | Non-holding part is formed |
| Comparative | None | Ultraviolet curable resin | Holding part at both surfaces |
| Example 1 | | | |
| Comparative | None | Silicone rubber resin | Holding part at both surfaces |
| Example 2 | | | |
| Comparative | None | Silicone rubber resin | Holding part at one surface |
| Example 3 | | | |
| Comparative | None | Silicone rubber resin | Holding part at one surface |
| Example 4 | | | Non-holding part is formed |

### Evaluation Method

### Maintaining of Shape Against Bending

Each optical fiber assemblage of the Examples and the Comparative Examples was placed between two aluminum plates and was bent at 90 degrees while maintaining R=30 mm, and this condition was held for 1 hour. After that, aluminum plates were removed to release the optical fiber assemblage, and the angle change from the condition of bending at 90 degrees was measured. That is, a measured value of 0 degrees means that the bending condition was completely maintained, and a measured value of 90 degrees means that the initial linear shape was returned to.

### Maintaining of Shape Against Twisting

Each optical fiber assemblage of the Examples and the Comparative Examples was placed between two aluminum plates and was twisted by 360 degrees by holding both edges, and this condition was held for 1 hour. After that, the aluminum plates were removed to release the optical fiber assemblage, and the angle change from the condition of twisting at 360 degrees was measured. That is, a measured value of 0 degrees means that the twisted condition was completely maintained, and a measured value of 360 degrees means that the initial linear shape was returned to.

The results are shown in Table 2.

TABLE 2

| | Maintaining of shape | Maintaining of shape |
|---|---|---|
| | against bending | against twisting |
| Example 1 | 10° | 15° |
| Example 2 | 3° | 10° |
| Example 3 | 3° | 10° |
| Example 4 | 2° | 10° |
| Comparative Example 1 | 75° | 300° |
| Comparative Example 2 | 60° | 280° |
| Comparative Example 3 | 55° | 280° |
| Comparative Example 4 | 50° | 280° |

### Results of Evaluations

Maintaining of shape against bending was 10° and against twisting was 15° in the case of the optical fiber assemblage of Example 1.

Since it can maintain its shape after it has been bent, accommodation in a tray or interconnection between devices or within a device can be performed in a short time and space is conserved, and furthermore, maintenance after arrangement can be performed efficiently.

Maintaining of shape against bending was 3° and against twisting was 10° in the case of the optical fiber assemblage of Example 2.

Since silicone rubber resin was used as the coating material of the optical fiber arranging part, flexibility was superior, and maintaining of shape against bending was superior. In addition, since it can be flexibly bent when handling, workability was superior.

Maintaining of shape against bending was 3° and against twisting was 10° in the case of the optical fiber assemblage of Example 3.

Since the holding part is only formed on one surface, flexibility was superior compared to Example 2, and the maintaining of shape against bending was especially superior. In addition, since it can be flexibly bent when handling, workability was superior.

Maintaining of shape against bending was 2° and against twisting was 10° in the case of the optical fiber assemblage of Example 4.

Since it has the non-holding part, flexibility was superior compared to Example 3, and since tension can be reduced when twisted, maintaining of shape against bending and twisting was especially superior. In addition, since it can be flexibly bent when handling, workability was superior.

As explained above, since the optical fiber assemblage of the Examples has superior characteristics of maintaining shape against bending, twisting, or both, optical fibers can be maintained in a desired shape, and furthermore, the optical fibers can be interconnected with good efficiency of construction and in small spaces.

On the other hand, the ability to maintain shape against bending was 50° to 75° and against twisting was 280° to 300° in the case of the optical fiber assemblage of Comparative Examples 1 to 4.

Since the characteristics of the Comparative Examples were inferior to those of the Examples, and since the optical fiber assemblages of the Comparative Examples had a tendency to return to the initial linear shape, it is difficult to maintain them in desired shapes and to interconnect with good efficiency of construction and in small spaces.

What is claimed is:

1. An optical fiber assemblage comprising:
optical fibers arranged in parallel;
at least one support wire having a shape-maintaining characteristic, arranged next to the optical fibers; and
a holding part holding the optical fibers and the support wire in a unified manner.

2. An optical fiber assemblage according to claim 1, wherein the holding part is made of a silicone rubber or resin material.

3. An optical fiber assemblage according to claim 1, wherein the holding part covers at least one of the both surfaces of the optical fibers and the support wire.

4. An optical fiber assemblage according to claim 1, wherein the outer diameter of the support wire L1 is not less than the outer diameter of the optical fiber L2.

5. An optical fiber assemblage according to claim 1, wherein the support wire is sandwiched between the optical fibers.

6. An optical fiber assemblage according to claim 1, wherein the support wire is a metallic wire.

7. An optical fiber assemblage according to claim 1, wherein the holding part is arranged at plural points.

8. An optical fiber assemblage according to claim 1, wherein the optical fibers cross over so as to switch.

9. An optical fiber assemblage according to claim 1, wherein the optical fibers are branched.
